(19) United States
(12) Patent Application Publication
(10) Pub. No.: US 2016/0172998 A1
(43) Pub. Date: Jun. 16, 2016

(54) POWER CONVERTER

(71) Applicant: Samsung SDI Co., Ltd., Yongin-si (KR)

(72) Inventors: Ki-Ok Lee, Yongin-si (KR); Kyu-Sung Cho, Yongin-si (KR)

(21) Appl. No.: 14/843,135

(22) Filed: Sep. 2, 2015

(30) Foreign Application Priority Data
Dec. 12, 2014 (KR) 10-2014-0179518

(51) Int. Cl. H02M 7/44

(52) U.S. Cl. CPC H02M 7/44

(57) ABSTRACT

A power converter is disclosed. In one aspect, the power converter includes a current sensor configured to sense an inverter current output from an inverter and output a first current having a direct current (DC) component and an alternating current (AC) component. The converter also includes a first circuit configured to extract the AC component, having a preset frequency or a frequency greater than the preset frequency, from the first current and output the extracted AC component as a second current. The converter further includes second circuit electrically connected to the current sensor and the first circuit, wherein the second circuit is configured to output a value substantially proportional to the DC component based on the second current.

### CROSS-REFERENCE TO RELATED APPLICATION

This application claims priority to and the benefit of Korean Patent Application No. 10-2014-0179518, filed on Dec. 12, 2014, in the Korean Intellectual Property Office, the entire content of which is incorporated herein by reference in its entirety.

### BACKGROUND

1. Field

The described technology generally relates to a power converter.

2. Description of the Related Technology

Inverters can convert direct current (DC) into alternating current (AC) by changing the direction of flow of the DC by repeating at high speed ON/OFF operations of a switch of transistors, thyristors and the like. However, due to switching timing of the switch, non-uniformity of saturation voltage and the like, a DC component can be included in inverter output current. Such DC component can have an undesirable effect on a device that is designed to be coupled to an inverter and to receive AC.

For instance, if a transformer is coupled to an inverter and if a DC component is included in the output current of the inverter, the caloric value of the transformer will naturally increase and therefore capacity can be reduced. If a motor is coupled to the inverter, motor rotation can become unstable.

### SUMMARY OF CERTAIN INVENTIVE ASPECTS

One inventive aspect relates to a power conversion device including a current sensor sensing current output from an inverter, a first current extractor extracting and outputting an alternating current (AC) having a preset frequency or greater from a first current sensed by the current sensor and a second current extractor coupled to the current sensor and the first current extractor, such that a direct current (DC) component current included in the first current is extracted by referring to a second current output from the first current extractor.

The first current extractor can include a high pass filter formed of a capacitor and a resistance or resistor and filters the DC component current included in the first current.

The second current extractor can include a differential amplifier circuit formed of a resistance and an operational amplifier and differential amplify an inverting input signal and a non-inverting input signal of the operational amplifier.

The resistance can be coupled to a non-inverting terminal and an inverting terminal of the operational amplifier, respectively, wherein an output terminal of the high pass filter is coupled to the resistance coupled to the inverting terminal of the operational amplifier.

The first current output from an output terminal of the current sensor can flow into a non-inverting terminal of the operational amplifier and the second current output from an output terminal of the high pass filter can flow into the inverting terminal of the operational amplifier.

A signal corresponding to an AC component current among current included in the first current due to an operation of the operational amplifier can be removed by a signal corresponding to the second current, and a signal corresponding to a DC component current among current included in the first current can be output to an output terminal of the operational amplifier.

An amplifying circuit including a resistance and an operational amplifier and amplifying magnitude of the first current and the second current can be further included.

The amplifying circuit can be coupled (i) between a resistance coupled to the inverting terminal of the operational amplifier and the high pass filter and (ii) between the non-inverting terminal of the operational amplifier and the output terminal of the current sensor, respectively.

A controller controlling output of the inverter can be further included such that a DC component is not included in a current output from the inverter by referring to a DC component current due to the second current extractor.

The controller can control output of the inverter such that a signal having a same magnitude as but having an opposite polarity from DC component current extracted by the second current extractor such that an analog waveform that represents current sensed by the current sensor oscillates based on 0.

Another aspect is a power converter comprising a current sensor configured to sense an inverter current output from an inverter and output a first current having a direct current (DC) component and an alternating current (AC) component, a first circuit configured to extract the AC component, having a preset frequency or a frequency greater than the preset frequency, from the first current and output the extracted AC component as a second current, and a second circuit electrically connected to the current sensor and the first circuit, wherein the second circuit is configured to output a value substantially proportional to the DC component based on the second current.

In the above power converter, the first circuit includes a high pass filter including a capacitor and a first resistance and configured to filter the DC component.

In the above power converter, the second circuit includes a differential amplifier circuit including second and third resistors and an operational amplifier having inverting and non-inverting terminals configured to respectively receive inverting and non-inverting input signals, wherein the differential amplifier circuit is configured to differentially amplify the inverting and non-inverting input signals.

In the above power converter, the second and third resistors are electrically connected to the non-inverting and inverting terminals of the operational amplifier, respectively, wherein an output terminal of the high pass filter is electrically to the third resistor.

In the above power converter, the first current is configured to flow into a non-inverting terminal of the operational amplifier, wherein the second current is configured to flow into an inverting terminal of the operational amplifier.

In the above power converter, the second circuit is further configured to remove the AC component from the first current based on the second current, wherein the operational amplifier is further configured to output the DC component at an output terminal of the operational amplifier.

The above power converter further comprises an amplifying circuit including first and second amplifying circuits and configured to amplify the magnitude of the first and second currents.

In the above power converter, the second circuit includes an operational amplifier having inverting and non-inverting input terminals, a second resistor electrically connected to the non-inverting terminal, and a third resistor electrically connected to the inverting terminal, wherein the second amplifying circuit is electrically connected between the third resistor and the first circuit, and wherein the first amplifying circuit is electrically connected to the non-inverting terminal of the operating amplifier and the output terminal of the current sensor.

The above power converter further comprises a controller configured to receive current data from the current detector and control the inverter based on the current data.

In the above power converter, the controller is further configured to control the inverter to output a signal having substantially the same magnitude as and an opposite polarity to the extracted DC component such that an analog waveform of the sensed inverter current has a DC voltage of about 0V.

Another aspect is a power converter comprising an inverter configured to receive direct current (DC) power from a power source and output an inverter current having a direct current (DC) component and an alternating current (AC) component and a current detector electrically connected to the inverter so as to receive the inverter current. The current detector comprises a current sensor configured to sense the inverter current and output a first current having the DC component and the AC component and a DC component detector configured to output a value substantially proportional to the DC component.

In the above power converter, the DC component detector comprises a first circuit configured to remove the DC component from the inverter current and extract the AC component and a second circuit configured to output a value substantially proportional to the DC component based on the inverter current and the DC component.

In the above power converter, the first circuit includes a high pass filter including a capacitor and a first resistor and configured to filter the DC component.

In the above power converter, the second circuit includes a differential amplifier circuit including second and third resistors and an operational amplifier having inverting and non-inverting terminals configured to respectively receive inverting and non-inverting input signals, wherein the differential amplifier circuit is configured to differentially amplify the inverting and non-inverting input signals.

In the above power converter, the second and third resistors are electrically connected to the non-inverting and inverting terminals of the operational amplifier, respectively, wherein an output terminal of the high pass filter is electrically to the third resistor.

In the above power converter, the inverter current is configured to flow into the non-inverting terminal of the operational amplifier, wherein an extracted current having the output AC component is configured to flow into an inverting terminal of the operational amplifier.

In the above power converter, the second circuit is further configured to remove the AC component from the inverter current based on the extracted current, wherein the operational amplifier is further configured to output the DC component at an output terminal of the operational amplifier.

The above power converter further comprises an amplifying circuit including first and second amplifying circuits and configured to amplify the magnitude of the inverter and extracted currents.

In the above power converter, the second circuit includes an operational amplifier having inverting and non-inverting input terminals, a second resistor electrically connected to the non-inverting terminal, and a third resistor electrically connected to the inverting terminal, wherein the second amplifying circuit is electrically connected between the third resistor and the first circuit, and wherein the first amplifying circuit is electrically connected to the non-inverting terminal of the operating amplifier and the output terminal of the current sensor.

In the above power converter, the controller is further configured to control the inverter to output a signal having substantially the same magnitude as and an opposite polarity to the extracted DC component such that an analog waveform of the sensed inverter current has a DC voltage of about 0V.

### BRIEF DESCRIPTION OF THE DRAWINGS

FIG. 1 schematically illustrates a power conversion device according to an embodiment.

FIG. 2 schematically illustrates a current detector of a power conversion device according to an embodiment.

FIG. 3 illustrates in detail the inside of a direct current component detector according to an embodiment.

FIG. 4 illustrates in detail the inside of a direct current component detector according to another embodiment.

### DETAILED DESCRIPTION OF CERTAIN INVENTIVE EMBODIMENTS

Recently, due to environmental concerns, solar photovoltaic devices that use solar battery panels and fuel cell generators using natural gas or hydrogen as fuel are finding increasing markets. Such generators convert the DC power generated by solar batteries into AC of commercial frequency through a power converter and link it to a commercial power system (e.g., the grid). Here, when the AC including the DC component is input into the commercial power system, a field distortion phenomenon can occur in the embedded transformers. As a result, there is a concern that this can have a negative effect on performance. Accordingly, a need exists to control an inverter device such that there is as little as possible of the DC component that flows from the inverter device into the commercial power system.

In the following detailed description, only certain exemplary embodiments of the described technology have been shown and described, simply by way of illustration. As those skilled in the art would realize, the described embodiments can be modified in various different ways, all without departing from the spirit or scope of the described technology. Accordingly, the drawings and description are to be regarded as illustrative in nature and not restrictive. In addition, it will be understood that when an element or layer is referred to as being “on”, “connected to” or “coupled to” another element or layer, it can be directly on, connected or coupled to the other element or layer or intervening elements or layers can be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings, of the described technology.

Spatially relative terms, such as “beneath”, “below”, “lower”, “above”, “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device can be otherwise oriented (rotated 90 degrees or at other orientations) and the spatially relative descriptors used herein interpreted accordingly.

The terminology used herein is for the purpose of describing particular embodiments only and is not intended to be limiting of the described technology. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this described technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

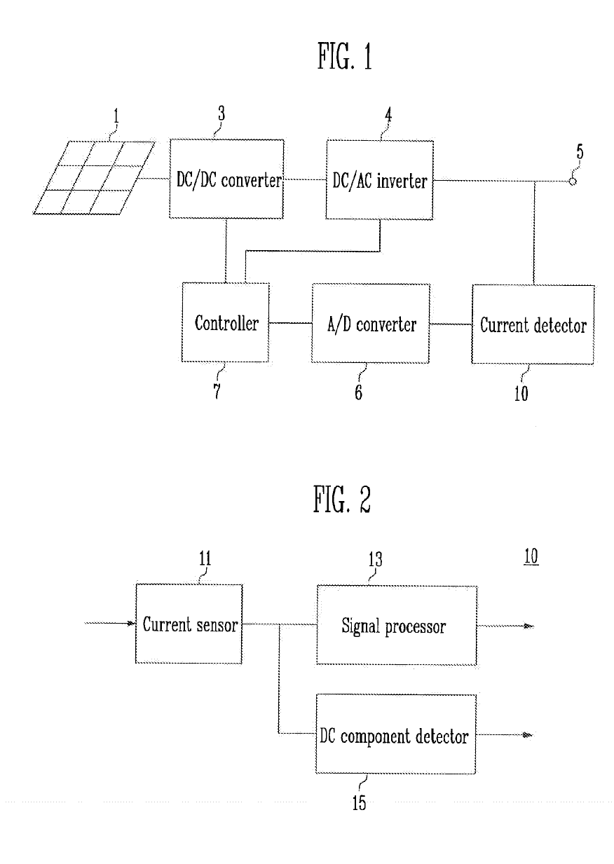

FIG. 1 schematically illustrates a power conversion device or power converter according to an embodiment.

As can be seen in FIG. 1, a power conversion device according to an embodiment includes a direct current (DC) power supply 1, a DC/DC converter 3, a DC to alternating current (AC) inverter 4, a current detector 10, an analog to digital and digital to analog (A/D) converter 6 and a controller 7. Although not shown in FIG. 1, an external load and a system can be coupled to an input/output terminal 5 of the power conversion device.

The DC power supply 1 can be a solar battery that generates electric power using sunlight and can generate power in the daytime. The solar battery can supply the power generated in the daytime to an external load (not shown) and supply remaining power unconsumed by a load to an additional energy storage device (not shown). The solar battery can supply surplus power to a system (not shown). DC voltage output from the solar battery is generally of low voltage. Therefore, output voltage can be increased by coupling a plurality of solar batteries in series.

Here, although the DC power supply 1 is described as the solar battery, it is not limited thereto. The DC power supply can be what outputs a predetermined DC voltage. For example, it is a secondary battery or a fuel cell.

The DC/DC converter 3 can perform a conversion operation of DC voltage that is output from the DC power supply 1 due to a driving signal of the controller 7. The DC/DC converter 3 can convert DC voltage generated by the DC power supply 1 into a scale needed for the DC/AC inverter 4.

The DC/AC inverter 4 can be coupled between the system (not shown) and the DC power supply 1 or the DC/DC converter 3. The DC/AC inverter 4 can perform an inverting operation based on the driving signal of the controller 7. The DC/AC inverter 4 can invert the DC voltage output from the DC/DC converter 3 into AC voltage that can be used at the system or the load or invert the AC voltage of the system (not shown) into DC voltage.

Though not illustrated, a capacitive device can be formed between the DC/DC converter 3 and the DC/AC inverter 4. The DC voltage applied from the DC/DC converter 3 can be substantially uniformly supplied to the DC/AC inverter 4.

A current detector 10 according to an embodiment measures current output from the DC/AC inverter 4 and extracts the DC component from the current output from the DC/AC inverter 4.

The current detector 10 is described further in detail below.

The A/D converter 6 can convert analog data output from the current detector 10, e.g., output current signal of the DC/AC inverter 4 measured at the current detector 10 or the DC component signal extracted from output current of the DC/AC inverter 4 into digital data that is equivalent thereto such that the controller 7 can perform calculations.

The controller 7 can be coupled to the DC/DC converter 3 and the DC/AC inverter 4 and perform unique functions at the DC/DC converter 3 and the DC/AC inverter 4 by controlling operations of the DC/DC converter 3 and DC/AC inverter 4 according to a current flow of the power conversion device. Operations of the DC/AC inverter 4 can be controlled such that the DC component is not included in the output current of the DC/AC inverter 4 by referring to an output current signal of the DC/AC inverter 4 and the DC component signal extracted from output current of the DC/AC inverter 4 obtained from the current detector.

The current detector 10 can be examined below, particularly with respect to the inner structure and function of each component.

FIG. 2 schematically illustrates a current detector of a power conversion device according to an embodiment.

A current detector according to an embodiment can include a current sensor 11, a signal processor 13 and a DC component detector 15.

The current sensor 11 can be coupled to the DC/AC inverter 4 to sense current output from the DC/AC inverter 4. Data of the current output from the DC/AC inverter 4 as sensed can be transferred to the signal processor 13 and the DC component detector 15. The current sensor 11 can be any one selected from a group of a hall sensor, shunt resistance and equivalents thereof, but is not limited thereto.

The signal processor 13 can process, convert and transfer the output signal of the current sensor such that signals output from the current sensor 11 can be digital signals processed at the controller 7.

The DC component detector 15 can extract the DC component from the output current of the DC/AC inverter 4. Data of the extracted DC component can be transferred to the controller 7. Though not illustrated in FIG. 2, the DC component detector 15 can include a buffer, and the like, that can perform the same or similar functions as the signal processor 13.

The DC component detector 15 is described below, particularly with respect to the inner structure and function of each component.

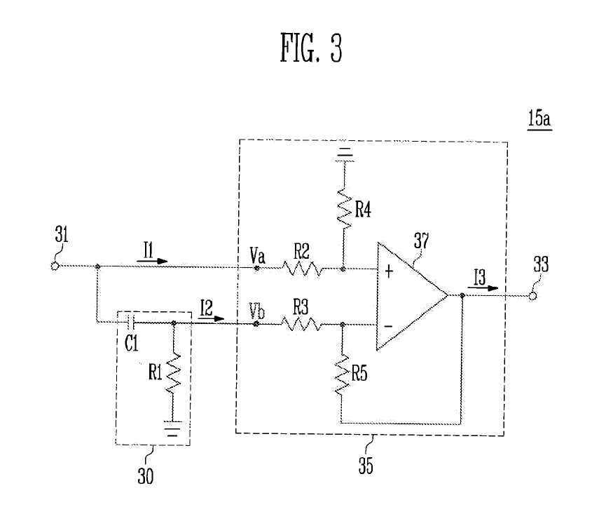

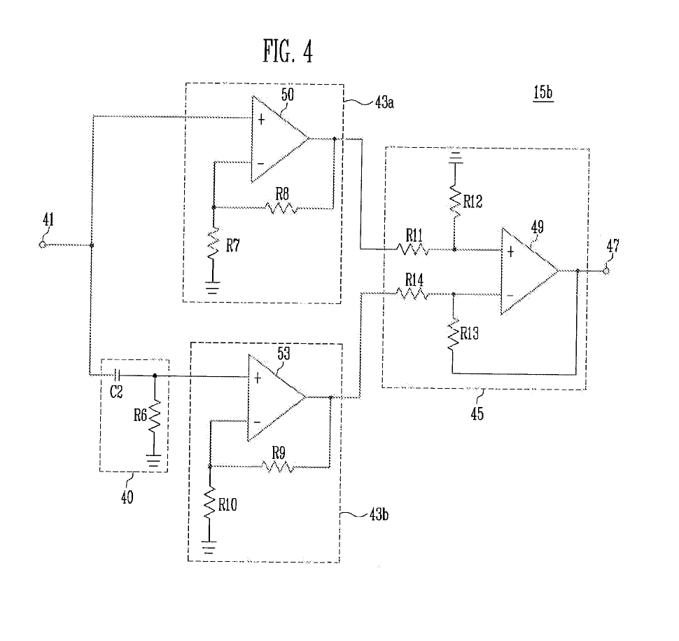

FIG. 3 illustrates in detail an inside of a direct current component detector according to an embodiment.

Referring to FIG. 3, a first DC component detector 15a includes a first current extractor or first circuit 30 and a second current extractor or second circuit 35. An output signal of the current sensor 11, that is, output current signal of the DC/AC inverter 4 can be input to an input terminal 31 of the first DC component detector 15a. Among the output current signals of the DC/AC inverter 4, a DC component signal can be output from an output terminal 33 of the first DC component detector 15a and transferred to the A/D converter.

The first current extractor 30 can extract AC current having a pre-set frequency or a greater frequency from a first current I1, which is an output current of the DC/AC inverter 4 as sensed by the current sensor 11.

The first current extractor 30 can receive data regarding the output current signal of the DC/AC inverter 4 sensed by the current sensor 11 and cause only the AC current having a value of a pre-set frequency or less to be output to the output terminal of the first current extractor 30.

The first current extractor 30 can filter the DC component included in the output currents of the DC/AC inverter 4. The pre-set frequency value herein described is not specified but can be any value that can filter the DC component having a frequency of 0 Hz.

The first current extractor 30 can be a high pass filter implemented with a capacitor C1 and a resistance R1. Only those signals having a cut-off frequency FC or a greater frequency as defined by the capacitor C1 and the resistance R1 can be output. The cut-off frequency fc can be defined as in Formula I below.

fc=½πR1C1 Formula I:

Since DC current can have a frequency of 0 Hz, if the output current of the DC/AC inverter 4 passes the high pass filter as described above, the DC component can be filtered by the high pass filter, and only those AC components having a predetermined frequency can be output from the high pass filter.

Since the first current extractor 30 can cause only the AC components, from the current output from the DC/AC inverter 4 (and not the DC components) to be output from the first current extractor 30, the capacitor C1 and the resistance R1 can be of any suitable value.

A second current extractor 35 can extract DC component included in the first current I1 by referring to a second current I2 that is an AC output from the first current extractor 30.

The second current extractor 35 can be a differential amplifier circuit that is implemented with a plurality of resistances R2 to R5 and an operational amplifier 37. At a non-inverting terminal of the operational amplifier 37, the resistance R2 and the resistance R4 can be coupled to each other. The resistance R2 can be coupled to an input terminal 31 of the first DC component detector 15a, and the resistance R4 can have one end coupled between the resistance R2 and the non-inverting terminal and the other end coupled to ground. At an inverting terminal of the operational amplifier 37, the resistance R3 and the resistance R5 can be coupled to each other. The resistance R3 can be coupled to the output terminal of the first current extractor 30 and the resistance R5 can have one end coupled between the resistance R3 and the inverting terminal, and the other end coupled to an output terminal of the operational amplifier 37.

The differential amplifier circuit that makes up the second current extractor 35 can differentially amplify an inverting input signal and a non-inverting input signal of the operational amplifier 37 and output the result. If a voltage value of one end of the resistance R2 is Va and a voltage value of one end of the resistance R3 is Vb, a voltage value of an output terminal of the operational amplifier 37 can be a value that is substantially proportional to (Vb−Va).

In some embodiments, the output current (the first current, I1) of the DC/AC inverter 4 sensed by the current sensor 11 flows into the non-inverting terminal of the operational amplifier via the resistance R2. The voltage Va can be substantially proportional to the magnitude of the first current, shown as a waveform oscillating around the magnitude of the DC component included in the first current. For example, if the DC voltage component included in the first current I1 is included in the voltage Va as much as about 1V, in a domain that represents a voltage (y-axis) according to time (x-axis), a waveform of AC voltage that oscillates around y=1 can appear.

The AC (the second current I2) from which DC component is removed among the output current of the DC/AC inverter 4 through the first current extractor 30 can flow into the inverting terminal of the operational amplifier 37 via the resistance R3. The voltage Vb, in a domain that represents the voltage (y-axis) according to time (x-axis), can be substantially proportional to the magnitude of the second current I2, and a waveform of AC voltage that oscillates based on y=0 can appear.

Accordingly, a*(Vb−Va) which is the voltage value of the output terminal of the operational amplifier 37 can be obtained from the AC voltage corresponding to the output current (first current I1 including both of AC and DC components) of the DC/AC inverter 4 except for AC voltage that corresponds to the second current I2 including only the AC component. In other words, the voltage value of the output terminal of the operational amplifier 37 can be the DC voltage value due to DC component current I3 included in the output current of the DC/AC inverter 4. For example, if the DC voltage component due to the DC component included in the first current I1 is included in the voltage Va as much as about 1V, then the voltage value of the output terminal of the operational amplifier 37 can be about a*1.

That is, as the output current of the DC/AC inverter 4 passes the first current extractor 30 and the second current extractor 35 sequentially, the DC component value that is included in the output current of the DC/AC inverter 4 can be extracted. The second current extractor 35 can transfer data relating to DC component current I3 to the controller 7 such that the DC component current I3 that is included in the output current I1 of the DC/AC inverter 4 can be removed by referring to the DC component current I3 extracted from the first DC component detector 15a and the output current I1 of the DC/AC inverter 4.

The controller 7 can receive data regarding the output current of the DC/AC inverter 4, data regarding the DC component current included in the output current of the DC/AC inverter 4, and data regarding the DC component current extracted by the DC component extractor 15. The controller 7 can control the output of the DC/AC inverter 4 such that the DC component is not included in the current output from the DC/AC inverter 4 by referring to the DC component current value extracted by the DC component detector 15.

As previously illustrated, if the DC component current value extracted from the DC component detector 15 is a value corresponding to about +1(V), in order to cause only the AC component to remain in the output current of the DC/AC inverter 4 by offsetting the extracted DC component, the output of the DC/AC inverter 4 can be controlled such that the DC component corresponding to about −1(V), for example, is included in the output current of the DC/AC inverter 4. The DC component and the extracted DC component can have substantially the same magnitude and have opposite polarities.

Typically, in order to measure the DC component current value included in the output current of the inverter, the A/D converter was used. There was a problem where a high-priced, high-precision A/D converter having a great number of bits must be used in order to measure a DC current value that is a predetermined ratio or less with respect to the amount of the AC included in the output current of the inverter, that is, a small DC current value. Also, there is a method of analyzing current sensed by the current sensor using harmonic analysis. However, this, too, requires a high speed digital signal processing device, and thus, a costly high-precision A/D converter must be used.

In some embodiments, since no costly high-precision A/D converter is required, extraction of DC component current can be made in a precise manner using only a small number of components, and therefore, it is economical. Also, since harmonic analysis is not used to detect DC component, DC component current can be extracted only based on the component without demanding increase in additional operation to extract DC component current from the existing digital operator.

Hereinafter, inner structure and function of each component of a DC component detector according to an embodiment will be described.

FIG. 4 illustrates in detail the inside of a direct current component detector according to another embodiment.

Referring to FIG. 4, a DC component detector includes an amplifying circuit in addition to the above-described first current extractor 40 and second current extractor 45. An output signal of a current sensor 11, that is, an output current signal of a DC/AC inverter 4 can be input into an input terminal 41 of a second DC component detector 15b. A DC component signal can be output among output current signals of the DC/AC inverter 4 from an output terminal 47 of the second DC component detector 15b and can be transferred to an A/D converter 6.

First and second amplifying circuits 43a and 43b can amplify the magnitudes of a first current I1 and a second current I2 before the first current I1 and the second current I2 flow into a non-inverting terminal and an inverting terminal, respectively, of an operational amplifier 49 of a second current extractor 45. According to another embodiment, accuracy in calculation result is enhanced by enlarging the magnitudes of the first current and the second current through the first and second amplifying circuits 43a and 43b, in comparing the first current with the second current at the differential amplifier circuit formed at the second current extractor 45.

The first and second amplifying circuits 43a and 43b can be implemented with a plurality of resistances R7 to R10 and operational amplifiers 50 and 53. The resistances R7 to R10 can be formed at the inverting terminal of the operational amplifiers 50 and 53. However, a portion of the resistances R7 and R10 can have one end coupled to ground, and remaining resistances R8 and R9 can have one end coupled to output terminals of the operational amplifiers 50 and 53, respectively.

The first and second amplifying circuits 43a and 43b can be formed at the first current line and the second current line, respectively, of the DC component detector 15b in order to amplify the first current I1 and the second current I2. The first amplifying circuit 43a that amplifies the first current I1 can be coupled between an input terminal 41 of the first DC component detector 15a and the second current extractor 45. The non-inverting terminal of the operational amplifier 50 formed at the first amplifying circuit 43a and the input terminal of the DC component detector 15b can be coupled to each other. A resistance R11 coupled to the non-inverting terminal of the operational amplifier 49 formed at the second current extractor 45 and the output terminal of the operational amplifier formed at the first amplifying circuit 43a can be coupled to each other. That is, the first current that has been amplified by the first amplifying circuit 43a can flow into the non-inverting terminal of the operational amplifier formed at the second current extractor 45 via the resistance R11.

The second amplifying circuit 43b that amplifies the second current I2 can be coupled between the first current extractor 40 and the second current extractor 45 implemented with a high pass filter. The output terminal of the first current extractor 40 can be coupled to the non-inverting terminal of the operational amplifier 53 formed at the second amplifying circuit 43b. The output terminal of the operational amplifier 53 formed at the second amplifying circuit 43b can be coupled to the resistance R14 coupled to the inverting terminal of the operational amplifier 49 formed at the second current extractor 45. The second current R2 that is amplified by the second amplifying circuit 43b can flow into the inverting terminal of the operational amplifier 49 formed at the second current extractor 45 via the resistance R14.

As for the AC components of the first current I1 and the second current I2, the DC component current included in the first current I1 can be extracted through differential amplification since the magnitude and direction are substantially the same. Therefore, the amplification ratio of the first amplifying circuit 43a and the second amplifying circuit 43b can be set to be the same. The amplification ratio β can be as Formula 2 below.

β=(R7+R8)/R7(R7=R10,R8=R9) Formula 2:

The second current extractor 45 can, as described above, differentially amplify and output an inverting input signal and a non-inverting input signal of the operational amplifier 49. If the voltage value of one end of the resistance R11 is β*Va, and if the voltage value of one end of the resistance R14 is β*Vb, the voltage value of the output terminal of the operational amplifier can be a value substantially proportional to β*(Vb−Va).

If the DC component current value included in the output current of the DC/AC inverter 4 is obtained by amplifying magnitude of the first and second current through the first and second amplifying circuits 43a and 43b and performing calculations, the controller 7 can control the output of the DC/AC inverter 4 by referring thereto. The DC component current value as obtained is divided as much as the amplified ratio, and the output of the DC/AC inverter 4 can be controlled such that a signal of substantially the same magnitude as the divided value and having an opposite polarity is included in the output current of the DC/AC inverter 4.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the present invention as set forth in the following claims.

What is claimed is:

1. A power converter comprising:
a current sensor configured to sense an inverter current output from an inverter and output a first current having a direct current (DC) component and an alternating current (AC) component;
a first circuit configured to extract the AC component, having a preset frequency or a frequency greater than the preset frequency, from the first current and output the extracted AC component as a second current; and
a second circuit electrically connected to the current sensor and the first circuit, wherein the second circuit is configured to output a value substantially proportional to the DC component based on the second current.

2. The power converter as claimed in claim 1, wherein the first circuit includes a high pass filter including a capacitor and a first resistance and configured to filter the DC component.

3. The power converter as claimed in claim 2, wherein the second circuit includes a differential amplifier circuit including second and third resistors and an operational amplifier having inverting and non-inverting terminals configured to respectively receive inverting and non-inverting input signals, and
wherein the differential amplifier circuit is configured to differentially amplify the inverting and non-inverting input signals.

4. The power converter as claimed in claim 3, wherein the second and third resistors are electrically connected to the non-inverting and inverting terminals of the operational amplifier, respectively, and
wherein an output terminal of the high pass filter is electrically to the third resistor.

5. The power converter as claimed in claim 3, wherein the first current is configured to flow into a non-inverting terminal of the operational amplifier, and wherein the second current is configured to flow into an inverting terminal of the operational amplifier.

6. The power converter as claimed in claim 5, wherein the second circuit is further configured to remove the AC component from the first current based on the second current, and
wherein the operational amplifier is further configured to output the DC component at an output terminal of the operational amplifier.

7. The power converter as claimed in claim 1, further comprising an amplifying circuit including first and second amplifying circuits and configured to amplify the magnitude of the first and second currents.

8. The power converter as claimed in claim 7, wherein the second circuit includes an operational amplifier having inverting and non-inverting input terminals, a second resistor electrically connected to the non-inverting terminal, and a third resistor electrically connected to the inverting terminal,
wherein the second amplifying circuit is electrically connected between the third resistor and the first circuit, and
wherein the first amplifying circuit is electrically connected to the non-inverting terminal of the operating amplifier and the output terminal of the current sensor.

9. The power converter as claimed in claim 1, further comprising a controller configured to receive current data from the current detector and control the inverter based on the current data.

10. The power converter as claimed in claim 9, wherein the controller is further configured to control the inverter to output a signal having substantially the same magnitude as and an opposite polarity to the extracted DC component such that an analog waveform of the sensed inverter current has a DC voltage of about 0V.

11. A power converter comprising:
an inverter configured to receive direct current (DC) power from a power source and output an inverter current having a direct current (DC) component and an alternating current (AC) component; and
a current detector electrically connected to the inverter so as to receive the inverter current, the current detector comprising:
a current sensor configured to sense the inverter current and output a first current having the DC component and the AC component; and
a DC component detector configured to output a value substantially proportional to the DC component.

12. The power converter as claimed in claim 11, wherein the DC component detector comprises:
a first circuit configured to remove the DC component from the inverter current and extract the AC component; and
a second circuit configured to output a value substantially proportional to the DC component based on the inverter current and the DC component.

13. The power converter as claimed in claim 12, wherein the first circuit includes a high pass filter including a capacitor and a first resistor and configured to filter the DC component.

14. The power converter as claimed in claim 13, wherein the second circuit includes a differential amplifier circuit including second and third resistors and an operational amplifier having inverting and non-inverting terminals configured to respectively receive inverting and non-inverting input signals, and
wherein the differential amplifier circuit is configured to differentially amplify the inverting and non-inverting input signals.

15. The power converter as claimed in claim 14, wherein the second and third resistors are electrically connected to the non-inverting and inverting terminals of the operational amplifier, respectively, and
wherein an output terminal of the high pass filter is electrically to the third resistor.

16. The power converter as claimed in claim 14, wherein the inverter current is configured to flow into the non-inverting terminal of the operational amplifier, and wherein an extracted current having the output AC component is configured to flow into an inverting terminal of the operational amplifier.

17. The power converter as claimed in claim 16, wherein the second circuit is further configured to remove the AC component from the inverter current based on the extracted current, and
wherein the operational amplifier is further configured to output the DC component at an output terminal of the operational amplifier.

18. The power converter as claimed in claim 12, further comprising an amplifying circuit including first and second amplifying circuits and configured to amplify the magnitude of the inverter and extracted currents.

19. The power converter as claimed in claim 18, wherein the second circuit includes an operational amplifier having inverting and non-inverting input terminals, a second resistor electrically connected to the non-inverting terminal, and a third resistor electrically connected to the inverting terminal,
wherein the second amplifying circuit is electrically connected between the third resistor and the first circuit, and
wherein the first amplifying circuit is electrically connected to the non-inverting terminal of the operating amplifier and the output terminal of the current sensor.

20. The power converter as claimed in claim 12, wherein a controller is further configured to control the inverter to output a signal having substantially the same magnitude as and an opposite polarity to the extracted DC component such that an analog waveform of the sensed inverter current has a DC voltage of about 0V.
